(19) United States
(12) Patent Application Publication
(10) Pub. No.: US 2015/0050914 A1
(43) Pub. Date: Feb. 19, 2015

(54) METHOD AND APPARATUS FOR VERIFYING A DEVICE DURING PROVISIONING THROUGH CALLER ID

(71) Applicant: VONAGE NETWORK LLC, Holmdel, NJ (US)

(72) Inventors: Itay Bianco, Tel-Aviv (IL); Tzahi Efrati, Hoboken, NJ (US); Baruch Sterman, Efrat (IL); Sagie Machlin, Rishon Lezion (IL); Ido Mintz, Burgata (IL)

(73) Assignee: VONAGE NETWORK LLC, Holmdel, NJ (US)

(21) Appl. No.: 13/965,433

(22) Filed: Aug. 13, 2013

(51) Int. Cl. H04W 12/06; H04W 12/04

(52) U.S. Cl. CPC H04W 12/06; H04W 12/04
USPC 455/411

(57) ABSTRACT

Methods and apparatus for verifying an end-user device during provisioning using caller ID (CID) are provided herein. In some embodiments, a method for verifying an end-user device during provisioning using CID may include receiving a first CID from the end-user device, associating a validation key with the first CID, sending a first signaling message to the end-user device including the validation key, receiving a second signaling message from the end-user device that includes a second CID, and performing a verification analysis of the end-user device using the second CID and the validation key.

### BACKGROUND

1. Field

Embodiments of the present invention generally relate to telecommunication systems and, more particularly, to a method and apparatus for verifying a device during provisioning using a caller ID.

2. Description of the Related Art

Telephony service providers and/or mobile app developers may wish to provide telephony services to an end user through an app. For example, telephony service providers may provide mobile apps that users can install on their smartphone, or other type of mobile devices, that allow users to make Voice over IP (VoIP) calls from their mobile phone.

Calls from a VoIP caller typically display the caller ID (CID) information of the caller to the called party. Upon installation/registration of the mobile VoIP app, the mobile VoIP app may prompt users to enter the phone number of the device before using the app. However, the user may potentially enter any phone number to be used as the CID since there is no inherent verification that the number provided is actually associated with the device (or even belongs to the user). That is, the inventor has observed that it is very easy for a VoIP caller to “spoof” his/her CID to appear as someone they are not. CID information is often centrally maintained on a Public Switched Telephone Network (PSTN) in a Caller Name (CNAM) database. Generally, service providers access the CNAM database to retrieve caller ID data. However, the CNAM request for information is based on the calling number that is provided by the caller and, in the case of a VoIP call, that number is freely editable by the caller without any verification. This prevents called parties from screening calls from unknown or undesirable callers (such as telemarketers).

Mobile apps may attempt to verify and update the “correct” device phone number through an automatic application programming interface (API) call to the device's operating system. However, this method is similarly deficient, as the device user could simply replace the device phone number with any number of her choosing, for example, by modifying the information in the phone's settings.

Other methods to prevent undesired spoofing may include independent verification that the claimed telephone number provided by the user is, in fact, associated with the user's device. This is typically done through an “out of band” channel that maps to that phone number, such as an SMS to that phone number that provides to the user, for example, a PIN that may be used to validate the device. However, this approach may be unreliable (e.g., SMS is not always available for a given device, SMS messages may be delayed at times). In addition, this method could potentially be abused by requesting “out of band” verifications to numbers owned by persons who have no desire to use the app. Alternatively, a telephone call may be used to convey validation information to the user. In either case, however, the “out of band” channel adds a layer of complexity and inconvenience to the installation/registration process.

Accordingly, there exists a need in the art for a convenient way to authenticate the association between a telephone number and a given device.

### SUMMARY

Methods and apparatus for verifying an end-user device during provisioning using caller ID (CID) are provided herein. In some embodiments, a method for verifying an end-user device during provisioning using CID may include receiving a first CID from the end-user device, associating a validation key with the first CID, sending a first signaling message to the end-user device including the validation key, receiving a second signaling message from the end-user device that includes a second CID, and performing a verification analysis of the end-user device using the second CID and the validation key.

In some embodiments, a method for verifying an end-user device during provisioning using CID may include sending the first CID to a telecommunication service provider, receiving a first signaling message including a validation key associated with the first CID, extracting the validation key from the first signaling message, and sending a second signaling message to the telecommunication service provider, wherein the validation key is included in a CID field in the second signaling message.

In some embodiments, a system for verifying an end-user device during provisioning using caller ID (CID) may include a transmission module configure to receive a first CID and a second CID from the end-user device, a key generation module configured to generate a validation key and associate it with the first CID received by the transmission module, and a device verification module configured to perform a verification analysis of the end-user device using the second CID and the validation key.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a system for verifying the authenticity of device information of a telephony device, according to one or more embodiments;

FIG. 3 depicts a flow diagram of a method for verifying the authenticity of device information of a telephony device, according to one or more embodiments;

FIG. 4 depicts a computer system that can be utilized in various embodiments of the present invention, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate methods and apparatus for verifying a device during provisioning using a caller ID (CID). Embodiments of the present invention advantageously improve upon the CID feature, particularly with respect to Voice over Internet Protocol (VoIP) service providers and mobile apps used in providing VoIP telephony service. More specifically, embodiments consistent with the present invention may include sending an identifier (i.e., telephone number) from an end-user device entered by an end-user to a telecommunication service provider for verification during provisioning of the end-user device, or during provisioning of a mobile app on the end-user device. In mobile telecommunication systems, provisioning is the process of preparing and equipping a telecommunication network and/or a mobile device to allow the mobile device to access telecommunication services. The identifier sent may be used to call the end-user device. The caller ID field in the signaling messages used to set up the call may be populated with a validation key which may be used to verify the calling number sent by the end-user device as will be described below in further detail.

In some embodiments, the client has access to APIs that will allow it to extract the CID (which contains the validation key) of the incoming call. The mobile app, for example, may subscribe to incoming call events/notifications. Once the notification is intercepted by the operating system of the mobile device, it notifies the mobile app, possibly with the CID/validation key as event data. Alternatively, the mobile app could call an API for the CID/validation key of the latest incoming call (within a certain time frame). A message may automatically be populated with the CID/validation key, and sent back to the network. The network verifies that the CID/validation key is the one that was sent and, if so, the device is verified and provisioned.

Those skilled in the art will appreciate that embodiments of the present invention can also be used with non-VoIP telephony mobile apps that may also need to verify the authenticity of identification information of a mobile device. Other and further embodiments of the present invention are described below.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the following description, the terms VoIP system, VoIP telephony system, Internet protocol (IP) system and IP telephony system are all intended to refer to a system that connects callers and that delivers data, text and video communications using IP data communications. After a user subscribes to a VoIP service, the user can make/receive phone calls to/from other VoIP subscribers or to public switched telephone network (PSTN) customers and access a number of features associated with the VoIP service, such as call waiting, three-way calling, call forwarding, voicemail service, and the like.

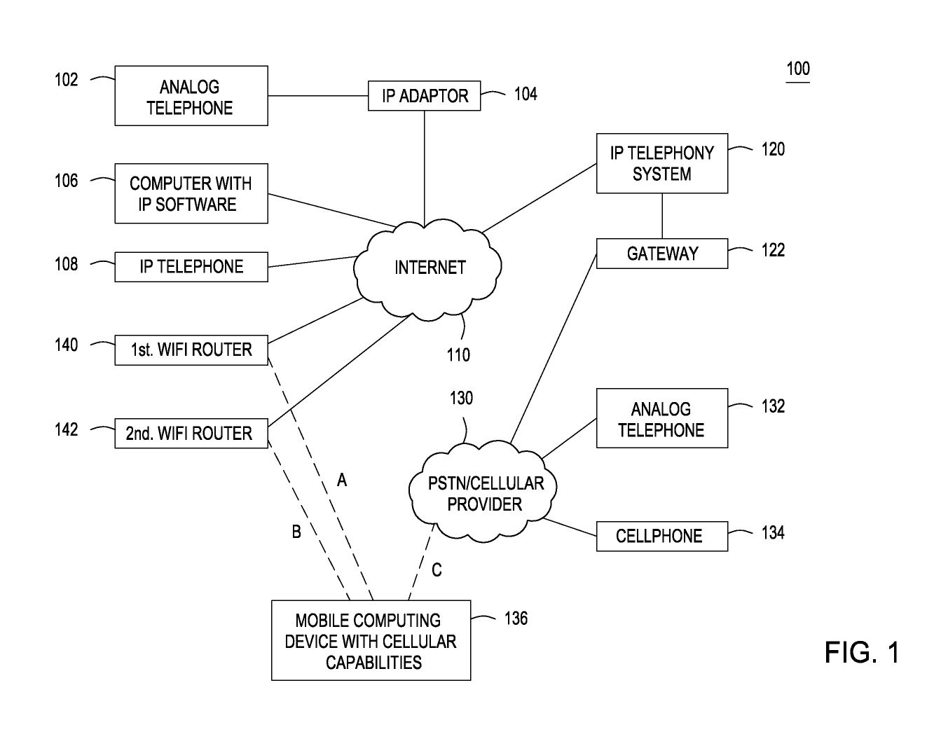

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a PSTN 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize the data channel of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 to place and receive IP based telephone calls, and to access other IP telephony systems (not shown). In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate calls over voice channels, and an IP telephone that can facilitate calls over data channels.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate mobile apps to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136 (e.g., a smartphone) is capable of establishing a first wireless data connection A with a first wireless access point 140, such as a WiFi or WiMax router. The first wireless access point 140 is coupled to the Internet 110. Thus, the mobile computing device 136 can establish a VOIP telephone call with the IP telephony system 120 via a path through the Internet 110 and the first wireless access point 140.

FIG. 1 also illustrates that the mobile computing device 136 can establish a second wireless data connection B with a second wireless access point 142 that is also coupled to the Internet 110. Further, the mobile computing device 136 can establish either a third wireless data connection C via a data channel provided by a cellular service provider 130 using its cellular telephone capabilities, or establish a telephone call via a voice channel provided by a cellular service provider 130. The mobile computing device 136 could also establish a VoIP telephone call with the IP telephony system 120 via the second wireless connection B or the third wireless connection C.

Although not illustrated in FIG. 1, the mobile computing device 136 may be capable of establishing a wireless data connection to a data network, such as the Internet 110, via alternate means. For example, the mobile computing device 136 might link to some other type of wireless interface using an alternate communication protocol, such as the WiMax standard.

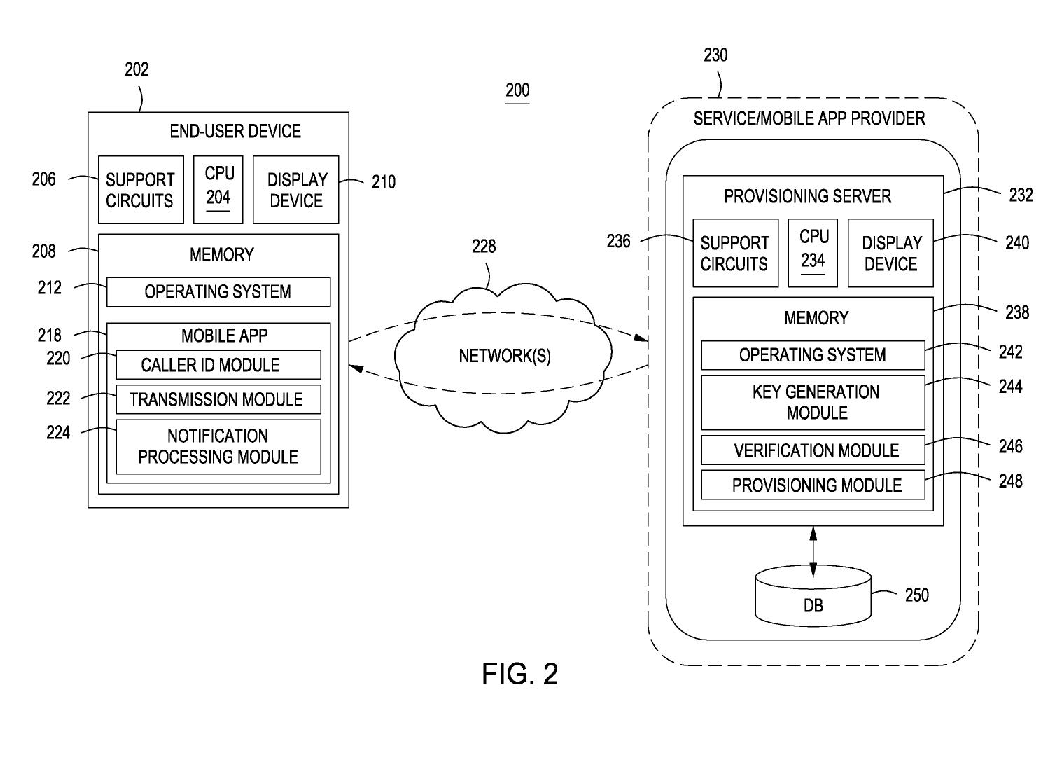

FIG. 2 depicts a block diagram of a system 200 for verifying the authenticity of device information of an end-user device, according to one or more embodiments. The system 200 comprises end-user device 202 and service provider provisioning system 230 communicatively coupled via networks 228. In some embodiments, end-user device 202 may be mobile computing device 136, and service provider provisioning system 230 may be IP telephony system 120 as described above in FIG. 1.

The end-user device 202 comprises a Central Processing Unit (CPU) 204, support circuits 206, memory 208, and a display device 210. The CPU 204 may comprise one or more commercially available microprocessors or microcontrollers that facilitate data processing and storage. The various support circuits 206 facilitate the operation of the CPU 204 and include one or more clock circuits, power supplies, cache, input/output device and circuits, and the like. The memory 208 comprises at least one of Read Only Memory (ROM), Random Access Memory (RAM), disk drive storage, optical storage, removable storage and/or the like. In some embodiments, the memory 208 comprises an operating system 212 and a mobile app 218.

The operating system (OS) 212 generally manages various computer resources (e.g., network resources, file processors, and/or the like). The operating system 212 is configured to execute operations on one or more hardware and/or software modules, such as Network Interface Cards (NICs), hard disks, virtualization layers, firewalls and/or the like. Examples of the operating system 212 may include, but are not limited to, various versions of LINUX, MAC OSX, BSD, UNIX, MICROSOFT WINDOWS, IOS, ANDROID and the like. In some embodiments, operating system 212 may include an application programming interface (API) which can be used to access and user device information and features (such as, for example, by mobile app 218).

In some embodiments, the mobile app 218 is a VoIP app that provides over-the-top (OTT) VoIP telephony services to an end-user. In some embodiments, OTT content describes broadband delivery of media/data/services without a traditional cellular service provider (e.g., PSTN provider 130) being involved in the control or distribution of the content itself. The provider may be aware of the contents of the IP packets but is not responsible for, nor able to control, the viewing abilities, copyrights, and/or other redistribution of the content. In some embodiments, an end-user may download the mobile app 218 from service provider system 230, or from an app distribution system associated with the service provider system 230, and install the mobile app 218 on their device. Although the mobile app 218 is described herein as a separate stand-alone application, in some embodiments the mobile app 218 may be integrated into OS 212, and may use existing API calls provided by the OS 212 to access or control various features of the end-user device 202.

In some embodiments mobile app 218 may include a caller ID (CID) module 220, transmission module 222, and a notification processing module 224. In some embodiments the caller ID (CID) module 220 may be used to obtain the calling identifier/number (i.e., the telephone number) of the end-user device 202 from the end-user. Transmission module 222 may be used to send and receive information that will be used to verify end-user device 202. In some embodiments, the transmission module 222 may encrypt all or a portion of the information that will be used by the system to verify the device information, or otherwise transmit the information in a secure format. In some embodiments, notification processing module 224 will process incoming notification messages and/or signaling messages to extract information included in said messages for verification/provisioning purposes.

The networks 228 comprise one or more communication systems that connect computers by wire, cable, fiber optic and/or wireless link facilitated by various types of well-known network elements, such as hubs, switches, routers, and the like. The networks 228 may include an Internet Protocol (IP) network (such as internet 110 of FIG. 1), a public switched telephone network (PSTN) (such as the PSTN network of PSTN provider 130 of FIG. 1), or other mobile communication networks, and may employ various well-known protocols to communicate information amongst the network resources.

In some embodiments, service provider provisioning system 230 may be a VoIP service provider or a mobile app developer. Service provider provisioning system 230 may include provisioning server 232 that may be used to verify the authenticity of the device information provided by end-user device 202 and provision the end-user device or a mobile app 218 running on end-user device 202. The provisioning server 232 comprises a Central Processing Unit (CPU) 234, support circuits 236, memory 238, and an optional display device 240. The CPU 234 may comprise one or more commercially available microprocessors or microcontrollers that facilitate data processing and storage. The various support circuits 236 facilitate the operation of the CPU 234 and include one or more clock circuits, power supplies, cache, input/output circuits, and the like. The memory 238 comprises at least one of Read Only Memory (ROM), Random Access Memory (RAM), disk drive storage, optical storage, removable storage and/or the like. In some embodiments, the memory 208 comprises an operating system 242, key generation module 244, verification module 246, and provisioning module 248. The operating system (OS) 242 generally manages various computer resources (e.g., network resources, file processors, and/or the like). The operating system 242 is configured to execute operations on one or more hardware and/or software modules, such as Network Interface Cards (NICs), hard disks, virtualization layers, firewalls and/or the like. Examples of the operating system 242 may include, but are not limited to, various versions of LINUX, MAC OSX, BSD, UNIX, MICROSOFT WINDOWS, IOS, ANDROID and the like.

In some embodiments, provisioning server 232 may be a entity that provides authentication/verification information to service provider provisioning system 230 by agreement. In some embodiments, provisioning server 232 accesses a database 250 that associates caller IDs with validation keys generated for each end-user device. Database 250 may be any data structure or data source that maintains an association of caller IDs and validation keys. The service provider provisioning system 230 may have direct or indirect access to database 250. For example, database 250 may exist on the service provider provisioning system 230 (direct access), or be accessible through a third party network (indirect access). For example, the service provider provisioning system 230 may be a VoIP service provider or a mobile app developer that provides OTT telephony services and may have agreements with trusted third-party providers to allow access to verification databases.

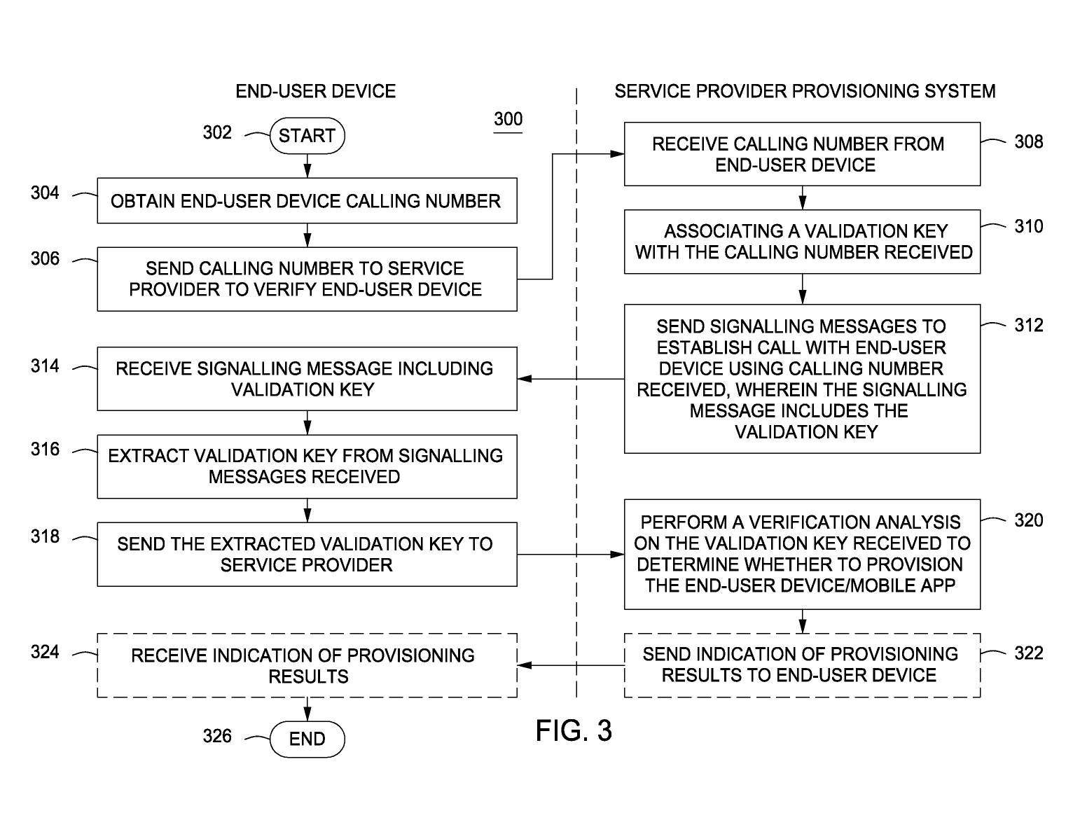

Exemplary methods that may be performed by one or more elements of system 200 for verifying authenticity of device information of an end-user device are described below with respect to FIG. 3. FIG. 3 depicts a flow diagram of a method 300 verifying authenticity of device information of an end-user device. The method 300 starts at 302 and proceeds to 304. At 304, a calling number of the end-user device is obtained. In some embodiments the caller ID (CID) module 220 may be used to obtain the calling identifier/number (i.e., the telephone number) of the end-user device 202 from the end-user. The calling number may be requested from the end-user by mobile app 218 via caller ID module 220 the first time mobile app 218 is launched. The end-user may input calling number via any number of input devices such as, for example, an end-user device keypad, on-screen keyboard, voice input, and the like. In some embodiments, the calling number may be automatically obtained by caller ID module 220 using API calls to the operating system.

At 306, the calling number may be sent to service provider provisioning system 230 for verification/provisioning purposes. The calling number may be sent the form of the signaling message, or other type of message via the transmission module 222 of mobile app 218. Exemplary message formats/protocols of any signaling message described herein may include a Type-Length-Value (TLV), XML, JAVASCRIPT OBJECT NOTATION (JSON), VCard, Hypertext Transfer Protocol (HTTP) and Hypertext Transfer Protocol Secure (HTTPS) message formats, SIP message formats, Signaling System 7 (SS7) message formats, SMS message formats, H323 message formats, Session Control Protocol (SCP) message formats, JINGLE-XMPP message formats, other GSM calling or CDMA calling signaling message formats not described above, and the like. For example, in some embodiments, the calling number/CID may be sent as an API request over HTTPS REGISTER message, or embedded in a SS7 signaling message. In other embodiments, a Session Initiation Protocol (SIP) message may be populated with the calling number, and sent back to the network. The calling number may be sent via Session Initiation Protocol (SIP) REGISTER or SIP KEEP-ALIVE messages. In some embodiments, the calling number may be provided to the VoIP provider in proprietary headers included in existing signaling mechanisms, such as SIP registration packets of keep-alive messages. SIP is a popular communication protocol for initiating, managing and terminating media (e.g., voice, data and video) sessions across packet based networks that typically use the Internet Protocol (IP) of which VOIP is an example. The details and functionality of SIP can be found in the Internet Engineering Task Force (IETF) Request for Comments (RFC) Paper No. 3261 entitled, “SIP: Session Initiation Protocol” herein incorporated in its entirety by reference. SIP establishes and negotiates a session, including the modification or termination of a session. It uses a location-independent address system feature in which called parties can be reached based on a party's name. SIP supports name mapping and redirection allowing users to initiate and receive communication from any location. Other signaling protocols may also be used to send the status attributes.

At 308, the message including the calling number from the end-user device provided by the end-user is received by the service provider provisioning system 230. The calling number is then extracted from the message received. A validation key is associated with the calling number at 310. In some embodiments, the validation key generated may be a random number or alphanumeric value associated with the calling number. In some embodiments, a push notification token may be used as the validation key. Specifically, a push notification token identifies an instance of a mobile app on a specific device. Other mobile apps on the same device will have a different ID. The same instance of a mobile app on a different device will also have a different ID. In some embodiments, the push notification token is generated as a result of a request from the mobile app the first time it is launched. In other embodiments key generation module 244 may generate the validation key by performing a hash function on the calling number universally unique identifier (UUID) as the validation key. A UUID is an identifier standard used in software construction, standardized by the Open Software Foundation (OSF) as part of the Distributed Computing Environment (DCE). The association of the calling number of the end-user device and the validation key generated may be stored in a database, for example, such as database 250.

In other embodiments, the validation key may be generated from a bank of mobile phones. For example, a telecommunication service provider may maintain a bank of X number of phones (separately or in a device that holds multiple SIM cards). A call may be placed to the end user device from one of the X provisioning system phones. The provisioning system phone that places the call may be randomly selected by the provisioning system. In this embodiment, the validation key would be the actual CID of the provisioning system phone that placed the call to the end-user device. As with the above embodiments, the association of the calling number of the end-user device and the validation key generated may be stored in a database, for example, such as database 250.

At 312, the provisioning server 232 will send signaling messages to establish a call with end-user device 202 using the calling number received. The provisioning server 232 will embed the validation key generated into the signaling messages sent to the end-user device. For example, in embodiments where the signaling message used to establish a telecommunication session is an HTTPS message, an SS7 message, or and SIP message the validation key may be stored in a CID field in the header or the body of the message. In other embodiments, For example, in embodiments where the signaling message used to establish a telecommunication session is an HTTPS message, an SS7 message, or a SIP INVITE message, the validation key may be stored in a caller ID field of the message, or other location in the header or the body of the message. In some embodiments, the validation key may be appended to a caller ID value or another type of caller identification value (e.g., an IMSI, IMEI, etc.). In other embodiments, only the validation key is stored in the caller ID field of the signaling message.

At 314, the signaling message including the validation key is received by the end-user device 202. Notification processing module 224 on end-user device 202 may subscribe to incoming calls or events. Thus when the signaling messages received at 314, notification processing module 224 may intercept the signaling message, or otherwise be notified of the signaling message, and may extract the validation key at step 316. At 318, the extracted validation key may be embedded/populated in a second signaling message (e.g., an HTTP response, an SS7 response, an SIP response message, and the like) that is subsequently sent back to the service provider provisioning system 230. In some embodiments, the extracted validation key may be appended to a caller ID value or another type of caller identification value (e.g., an IMSI, IMEI, etc.) in the second signaling message. In other embodiments, only the validation key is stored in the caller ID field of the second signaling message.

Once the second signaling message is received by the service provider provisioning system 230 at step 320, a verification analysis is done on the validation key by verification module 246 to determine whether the end-user device 202 and/or the mobile app 218 should be provisioned by the service provider provisioning system 230. The verification analysis may include comparing the validation key received to the one sent to end-user device 202, performing a hash function on the validation key, and the like. In embodiments where the validation key is encrypted, the validation key may be decrypted before performing the comparison.

If the verification analysis performed indicates that the validation key has been verified the mobile app 218 and/or user device 202 will be provisioned by the service provider provisioning system 230. If the validation key was not verified, the mobile app 218 and/or the user device 202 will not be provisioned in the mobile app 218. In some embodiments, if a 218 and/or the user device 202 has not been provisioned, the 218 and/or the user device 202 will be prohibited from using the telecommunication services of the service provider system 230. In some embodiments, an error message may be sent to the device to retry the provisioning process. If after X failed attempts, the provisioning system may ban the calling number used for a period of time. In other embodiments, if the validation key was not verified, the user device may be provisioned to access only a limited set of services, or may only be provided access to information services (e.g., troubleshooting page, service provider home page, FAQ, rate page, and the like).

In some embodiments, service provider provisioning system 230 may optionally send an indication of the provisioning/verification results to the end-user device 202 at step 322. At 324, end-user device will receive the indication of the present provisioning results. The method 300 ends at 326.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

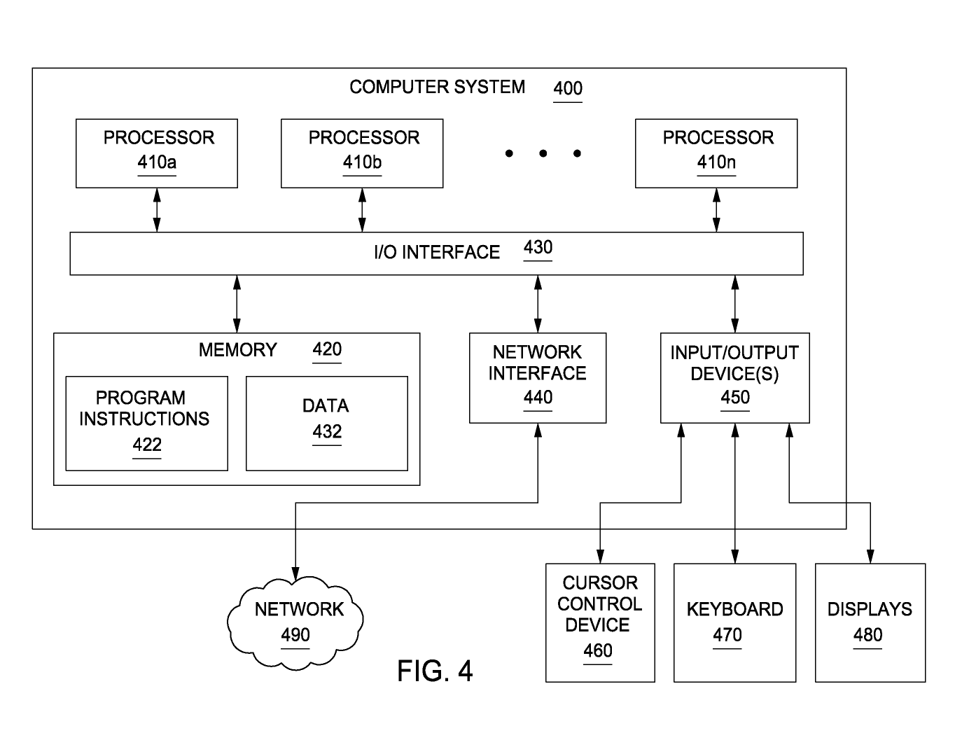

FIG. 4 depicts a computer system 400 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement methods described above. The computer system 400 may be used to implement any other system, device, element, functionality or method of the above-described embodiments. In the illustrated embodiments, computer system 400 may be configured to implement method 300 as processor-executable executable program instructions 422 (e.g., program instructions executable by processor(s) 410) in various embodiments.

In the illustrated embodiment, computer system 400 includes one or more processors 410a-410n coupled to a system memory 420 via an input/output (I/O) interface 430. Computer system 400 further includes a network interface 440 coupled to I/O interface 430, and one or more input/output devices 450, such as cursor control device 460, keyboard 470, and display(s) 480. In various embodiments, any of the components may be utilized by the system to receive user input described above. In various embodiments, a user interface may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410 may be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the methods described above, such as the methods illustrated by the flowchart of FIG. 3. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for verifying an end-user device during provisioning using caller ID (CID) comprising:
receiving a first CID from the end-user device;
associating a validation key with the first CID;
sending a first signaling message to the end-user device including the validation key;
receiving a second signaling message from the end-user device that includes a second CID; and
performing a verification analysis of the end-user device using the second CID and the validation key.

2. The method of claim 1, wherein the first CID is one of a telephone number or an Internet Protocol (IP) address of the end-user device.

3. The method of claim 1, wherein the first signaling message is a call request to establish a telecommunication session using the first CID received.

4. The method of claim 1, wherein the first and second signaling messages are each one of a Hypertext Transfer Protocol (HTTP) message, a Hypertext Transfer Protocol Secure (HTTPS), a Signaling System 7 (SS7) message, or a Session Initiation Protocol (SIP) message.

5. The method of claim 1, wherein the validation key is stored in a database in association with the first CID.

6. The method of claim 1, wherein the validation key included in the first signaling message is encrypted.

7. The method of claim 1, wherein the verification analysis performed includes:
comparing the validation key with the second CID; and
determining that the end-user device is verified when the validation key and the second CID match.

8. The method of claim 7, wherein determining that the end-user device is verified causes a mobile app on the end-user device to be provisioned to allow the mobile app to access telecommunication services of a telecommunication service provider.

9. The method of claim 8, wherein the telecommunication service provider is a Voice over Internet Protocol (VoIP) service provider, and wherein the mobile app is a VoIP mobile app.

10. The method of claim 8, further comprising:
sending the end-user device an indication that the end-user device has been provisioned to access the telecommunication services of the telecommunication service provider.

11. The method of claim 1, wherein the verification analysis performed includes:
comparing the validation key with the second CID; and
determining that the end-user device is not verified when the validation key and the second CID do not match.

12. The method of claim 11, further comprising:
sending the end-user device an indication that the end-user device has not been verified and/or provisioned to access telecommunication services of a telecommunication service provider.

13. The method of claim 12, wherein the end-user will be prohibited from using the telecommunication services of the telecommunication service provider.

14. The method of claim 1, wherein the validation key is appended to another caller identifier value and stored in a CID field of the first signaling message.

15. The method of claim 14, wherein the verification analysis performed includes:
comparing the validation key with a portion of the second CID; and
determining that the end-user device is verified when the validation key and the portion of the second CID match.

16. The method of claim 1, wherein the first signaling message is an SMS message directed to the first CID received, and wherein the validation key is stored in a CID field of the SMS message.

17. The method of claim 16, wherein second signaling message is a second SMS message, and wherein the second CID is stored in a CID field of the second SMS message.

18. A method verifying an end-user device during provisioning using caller ID (CID) comprising:
sending a first CID to a telecommunication service provider;
receiving a first signaling message including a validation key associated with the first CID;
extracting the validation key from the first signaling message; and
sending a second signaling message to the telecommunication service provider, wherein the validation key is included in a CID field in the second signaling message.

19. The method of claim 18, wherein the first CID is one of a telephone number or an Internet Protocol (IP) address of the end-user device.

20. The method of claim 18, wherein the first CID is received via manual entry by an end-user in response to a request to provide CID information.

21. The method of claim 18, the first CID is obtained via at least one Application Programming Interface (API) call to an operating system running on the end-user device.

22. The method of claim 18, wherein the first signaling message is a call request to establish a telecommunication session.

23. The method of claim 18, wherein the first and second signaling messages are each one of a Hypertext Transfer Protocol (HTTP) message, a Hypertext Transfer Protocol Secure (HTTPS), a Signaling System 7 (SS7) message, or a Session Initiation Protocol (SIP) message.

24. The method of claim 18, further comprising:
receiving an indication that a mobile app on the end-user device has been provisioned to access telecommunication services of the telecommunication service provider.

25. The method of claim 24, wherein the telecommunication service provider is a Voice over Internet Protocol (VoIP) service provider, and wherein the mobile app is a VoIP mobile app.

26. The method of claim 18, wherein the validation key is extracted from a CID field of the first signaling message.
